(19) United States
(12) Patent Application Publication
(10) Pub. No.: US 2025/0382403 A1
(43) Pub. Date: Dec. 18, 2025

(54) PROCESS FOR MANUFACTURING AQUEOUS DISPERSION COMPRISING PARTICLES OF A FLUORINATED POLYMER (F)

(71) Applicant: SOLVAY SPECIALTY POLYMERS ITALY S.P.A., Bollate (Milano) (IT)

(72) Inventors: Alessio Marrani, Lecco (IT); Cristiano Monzani, Trezzo sull'Adda (IT); Vito Tortelli, Milano (IT); Federica Maggioni, Lainate (IT)

(73) Assignee: SOLVAY SPECIALTY POLYMERS ITALY S.P.A., Bollate (Milano) (IT)

(21) Appl. No.: 18/877,163

(22) PCT Filed: Jun. 9, 2023
(86) PCT No.: PCT/EP2023/065537

§ 371 Date: Dec. 19, 2024

(30) Foreign Application Priority Data
Jun. 23, 2022 (EP) 22180673.0

(51) Int. Cl. C08F 214/22; C09D 127/16

(52) U.S. Cl. CPC C08F 214/22; C09D 127/16

(57) ABSTRACT

The invention relates to a process for manufacturing an aqueous dispersion comprising particles of a fluorinated polymer (F) comprising at least recurring units derived from a C₂-C₃ hydrofluoroolefin (HFO), said process comprising free radical polymerization in aqueous medium of at least one C₂-C₃ hydrofluoroolefin (HFO) in the presence of at least one partially fluorinated surfactant (S) and relates to a latex obtained by said process.

This application claims priority from the European patent application filed on 23 Jun. 2022 in EUROPE with Nr 22180673.0, the whole content of this application being incorporated herein by reference for all purposes.

The invention pertains to a process for manufacturing aqueous dispersion comprising particles of a fluorinated polymer (F) using at least one partially fluorinated surfactant (S) and to latex obtained via such a process.

Known preparation methods of fluorinated polymers are aqueous polymerization involving fluorinated surfactants. Just for the sake of example, such methods are described in WO2018/189091 and WO2018/189092 from Solvay specialty Polymers Italy S.p.a.

As well known, the use of certain fluorinated surfactants may be restricted for environmental reasons because there are not biodegradable in an acceptable lapses of time or conditions ranges. Therefore there is a continued demand for new surfactants, suitable for preparing fluorinated polymers through aqueous polymerization processes in the presence or in the absence of nucleating agents, having improved biodegradability features.

Non-fluorinated surfactants such as alkyl phosphates, alkyl sulfonates, alkyl sulfates, or alkyl carboxylates are generally not appropriate to be used in aqueous free radical polymerization of fluorinated or partially fluorinated monomers since they bear H atoms likely to be abstracted during polymerization process by free radical species. These transfer reactions lead to fluorinated polymers having low molecular weights and thus having impaired properties.

Therefore there is a demand for new surfactants, suitable for preparing fluorinated polymers through aqueous free radical polymerization processes in the presence or in the absence of nucleating agents, with only limited transfer reactions and ensuring good stabilization of the aqueous dispersion of the resulting fluorinated polymers.

It has been surprisingly found that the partially fluorinated surfactants according to the invention were highly degradable while suitable to carry out the manufacture of aqueous dispersion comprising particles of fluorinated polymers through aqueous free radical polymerization processes.

The invention relates to a process for manufacturing an aqueous dispersion comprising particles of a fluorinated polymer (F) comprising at least recurring units derived from a C₂-C₃ hydrofluoroolefin (HFO), said process comprising free radical polymerization in aqueous medium of at least one C₂-C₃ hydrofluoroolefin (HFO) in the presence of at least one partially fluorinated surfactant (S) selected from the group consisting of compounds of formula (I) R—CFX—P (I), formula (II) P—CFX—(CH₂)ₙ—CFX—P (II), and formula (III) R—CF(—P)₂ wherein
R is an optionally branched C₃-C₁₆ alkyl or alkenyl chain, optionally comprising one or more than one catenary heteroatoms selected from N, O and S, optionally comprising a carbonyl group, optionally comprising one or more than one halogen atoms selected from Cl, Br and I, and optionally comprising C₃-C₈ aliphatic cycles,
n is an integer from 2 to 16
—P represents —COO—M, —SO₃—M or —PO₃—M, wherein M is H, or an alkali metal, or an ammonium group N(R′)₄, wherein R′, equal or different at each occurrence, is a hydrogen atom or a C₁-C₆ hydrocarbon group preferably an alkyl group, and
X is H or F.

Generally, the surfactant (S) responds to formula (I) R—CFX—P (I), to formula (II) P—CFX—(CH₂)ₙ—CFX—P (II), or to formula (III) R—CF(—P)₂ wherein
R is an optionally branched C₃-C₁₆ alkyl or alkenyl chain, optionally comprising one or more than one catenary heteroatoms selected from N, O and S, optionally comprising a carbonyl group, optionally comprising one or more than one halogen atoms selected from Cl, Br and I, and optionally comprising C₃-C₈ aliphatic cycles,
n is an integer from 2 to 16.
—P represents —COO—M, —SO₃—M or —PO₃—M, wherein M is H, or an alkali metal, or an ammonium group N(R′)₄, wherein R′, equal or different at each occurrence, is a hydrogen atom or a C₁-C₆ hydrocarbon group preferably an alkyl group, and
X is H or F.

In some embodiments M is an ammonium group, more preferably NH₄ group.

In some preferred embodiments —P represents —COO—M and in more preferred embodiments —P represents —COO—NH₄.

In some embodiments, R is a linear C₃-C₁₆ fully hydrogenated alkyl chain. In some other embodiments R is an optionally branched C₃-C₁₆ alkyl or alkenyl chain, comprising a carbonyl group.

Still in some other embodiments, R is an optionally branched C₃-C₁₆ alkyl or alkenyl chain comprising one or more than one catenary heteroatoms selected from N, S and S, e.g. R comprises one or more than one ether group, R comprises one or more than one thioether group or R comprises one or more than one amine group.

In some embodiments, R is an optionally branched C₃-C₁₆ alkyl or alkenyl chain comprising a catenary N atom and a carbonyl group, e.g. R comprises an amide group.

In some other embodiments, R is an optionally branched C₃-C₁₆ alkyl or alkenyl chain comprising a catenary O atom and a carbonyl group, e.g. R comprises an ester group,

Still in some other embodiments R is an optionally branched C₃-C₁₆ alkyl or alkenyl chain, comprising one or more than one halogen atoms selected from Cl, Br and I.

In some embodiments, R is an optionally branched C₃-C₁₆ alkyl or alkenyl chain comprising C₃-C₈ aliphatic cycles, e.g. comprises C₆ aliphatic cycle. In some embodiments surfactant (S) is selected from the group consisting of R—CFH—COO—NH_{4, 4}HN—OOC—CFH—(CH₂)ₙ—CFH—COO—NH₄ and R—CFH—(COO—NH₄)₂, wherein R and n are as above described.

Good results were obtained with surfactant (S) being CH₃(CH₂)₇CFHCOO—NH₄.

In some embodiments surfactant (S) is selected from the group consisting of R—CFH—COO—NH₄ and R—CFH—(COO—NH₄)₂, wherein R is as above described and R comprises a carbonyl group.

In some preferred embodiments surfactant (S) is CH₃—CO—(CH₂)₇CFHCOO—NH₄.

For the sake of example, surfactant (S) according to the invention can be synthesized according to the following reaction scheme:

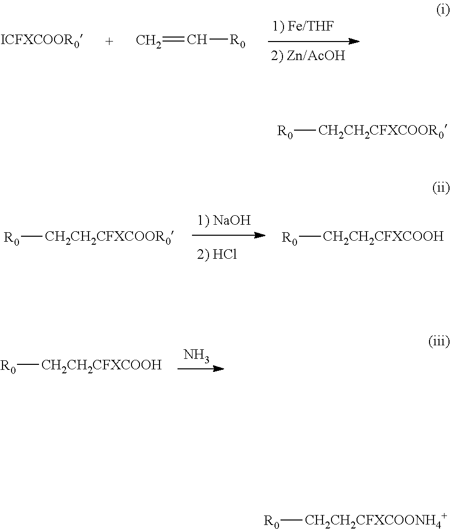

wherein X is H, or F, R₀′ is a C₁-C₃ hydrogenated alkyl chain, preferably ethyl group, and R₀ is a C₁-C₁₄ hydrogenated optionally branched alkyl chain, optionally comprising a carbonyl group.

ICFXCOOR₀′ can be prepared from bromide or chloride analog, BrCFXCOOR₀′ or CICFXCOOR₀′, according to reaction pathway described in Journal American Chemical Society, 2001, vol.123, no. 30, pages 7207-7219 or in Journal of Chemical Society, Perkin Trans. 1, 1996, 1741-47.

The addition of iodinated derivative onto unsaturated compound as represented in reaction (i) step 1) can be performed as described in Journal of Chemical Society, Perkin Trans.1, 1996, 1741-47 using Fe in tetrahydrofuran. Other method e.g. involving the use of sodium dithionite Na₂S₂O₄ as described in Journal of Fluorine Chemistry, 2005, 126, pages 63-67 may be used. Examples of synthesis involving unsaturated compounds comprising electron withdrawing groups such as carbonyl group can be found in Journal of Chemical Society, Perkin Trans. 1, 1996, 1741-47.

Further reduction by Zn in acetic acid as represented in i) step 2) is described in Journal of Chemical Society, Perkin Trans.1, 1996, 1741-47 or Journal of Fluorine Chemistry, 1992, vol. 59, pages 9-14.

Recovery of the carboxylic acid from the alkyl ester, e.g. ethyl ester, as represented in (ii) is for example described in Tetrahedron, 1994, vol.50, nº33, pages 9847-9864.

The preparation of the ammonium salt of the carboxylic acid as described in (iii) is well known by the person of ordinary skill in the art.

Other methods can be used to prepare surfactant (S). Without being limited and for the sake of example, a route for the preparation of the intermediate ethyl ester of formula R—CH₂CH₂CFXCOOEt which does not involve the use of ICFXCOOEt can be found in Tetrahedron, 1994, vol.50, nº33, pages 9847-9864. The biodegradability of surfactant (S) was assessed according to the carbon dioxide (CO₂) evolution test (Reference TG301 B) described by the OECD (Organization for Economic Co-Operation and Development) in “OECD Guideline for testing of chemicals No. 301 B”: https://read.oecd-ilibrary.org/environment/test-no-301-ready-biodegradability_9789264070349-en #page18.

According to this method a solution of the test substance in a mineral medium is inoculated with activated sludge and incubated under aerobic conditions.

Degradation is then determined by measuring the actual CO₂ production in comparison to the theoretical CO₂ that would be produced if the test compound was fully mineralized. CO₂ measurements are taken with a frequency that allowed the identification of the beginning and end of biodegradation.

A reference compound known to be biodegradable is run in parallel to check the validity of the procedures. The average value of biodegradation is calculated on the results obtained in 4 replicates.

According to the “Guidelines for the testing of chemicals. Revised introduction to the OECD guidelines for testing of chemicals, Section 3, Part 1, Chapter 2.3 (Adopted Mar. 23, 2006)”:

A mono-constituent chemical is found to be ready biodegradable if the two following conditions are met:
1) it gives a result of at least 60% biodegradation within 28 days;
2) the pass level is reached within the 10 days immediately following the attainment of 10% biodegradation (10-day window).

For the chemicals giving a result of at least 60% biodegradation within 28 days but failing the 10-day window criteria are concluded to be not ready biodegradable, however they are still considered ultimately biodegradable, which means that they are expected to be completely mineralized in the environment.

For the chemicals not reaching the 60% biodegradation within 28 days, the enhanced ready biodegradability test foresees the prolongation of the testing period up to a maximum of 60 days (see ECHA Guidance on Information Requirements and Chemical Safety Assessment Chapter R.7b: Endpoint specific guidance Version 4.0 (June 2017) and ECHA Guidance on Information Requirements and Chemical Safety Assessment-Chapter R. 11: PBT/vPvB assessment version 3.0, June 2017). A result of at least 60% biodegradation within 60 days is part of the evidence that the test item is not persistent. The chemicals not giving a result of at least 60% biodegradation within 60 days are potentially persistent and need further assessment for concluding on their persistence properties.

Generally, the partially fluorinated surfactants according to the invention fulfill at least the pass level criterion which is 60% biodegradation, supporting the absence of persistence.

Surprisingly, the partially fluorinated surfactants according to the invention bearing —CHF— groups fulfill the two above mentioned conditions i.e. at least 60% biodegradation within 28 days and 10-day window criteria.

Moreover, it has been found, that partially fluorinated surfactants (S) according to the invention were well suited to be used in process for manufacturing an aqueous dispersion comprising particles of a fluorinated polymer (F) comprising at least recurring units derived from a C₂-C₃ hydrofluoroolefin (HFO), said process comprising free radical polymerization in aqueous medium of at least one C₂-C₃ hydrofluoroolefin (HFO).

Without being bonded to any theory, it appears that F atom(s) on a carbon of polar acidic group salt of surfactants (S) according to the invention, on one hand tends to limit the transfer reactions during the free radical polymerization of fluorinated monomers and, on the other hand allows surfactants (S) stabilizing the aqueous dispersion of the fluorinated polymer (F).

One or more surfactant (S) as defined above may be added to the aqueous free radical polymerization medium of the process of the invention in a total amount ranging advantageously from 0.001% to 20% by weight based on the weight of the aqueous polymerization medium.

Generally, the fluorinated polymer (F) comprises at least recurring units derived from a C₂-C₃ hydrofluoroolefin (HFO) and is obtained by free radical polymerization in aqueous medium of at least one C₂-C₃ hydrofluoroolefin (HFO).

The C₂-C₃ hydrofluoroolefin (HFO) according to the present invention is generally selected from the group consisting of vinylidene fluoride (VDF), fluoroethylene, cis-1,2-difluoroethylene, trans-1,2-difluoroethylene, trifluoroethylene, 2,3,3,3-tetrafluoropropylene, cis-1,3,3,3-tetrafluoropropylene, trans-1,3,3,3-tetrafluoropropylene, cis-1,2,3,3-tetrafluoropropylene, trans-1,2,3,3-tetrafluoropropylene, 1,1,3,3-tetrafluoropropylene, 1,1,2,3-tetrafluoropropylene, cis-1,2,3,3,3-pentafluoropropylene, trans-1,2,3,3,3-pentafluoropropylene, 1,1,3,3,3-pentafluoropropylene, 1,1,2,3,3-pentafluoropropylene, 3,3,3-trifluoropropylene, 2,3,3-trifluoropropylene, cis-1,3,3-trifluoropropylene, trans-1,3,3-trifluoropropylene, cis-1,2,3-trifluoropropylene, trans-1,2,3-trifluoropropylene, 1,1,3-trifluoropropylene, 1,1,2-trifluoropropylene and mixtures thereof.

Preferably, the C₂-C₃ hydrofluoroolefin (HFO) is vinylidene fluoride (VDF) or 2,3,3,3-tetrafluoropropylene, preferably it is vinylidene fluoride (VDF).

Is some embodiments, the fluorinated polymer (F) consists essentially of recurring units derived from vinylidene fluoride (VDF).

In some other embodiments, the fluorinated polymer (F) further comprises recurring units derived from at least one additional fluorinated monomer and thus is obtained by free radical polymerization in aqueous medium of at least one C₂-C₃ hydrofluoroolefin (HFO) and said at least one additional fluorinated monomer.

By additional fluorinated monomer is meant an ethylenically unsaturated monomer comprising at least one fluorine atom. The choice of this additional fluorinated monomers is not particularly limited, any fluorinated monomer can be used.

The additional fluorinated monomer may further comprise one or more other halogen atoms (Cl, Br, I) and may be partially or fully halogenated. Non-limiting examples of additional (per) fluorinated monomers include:
C₂-C₈ perfluoroolefins such as tetrafluoroethylene (TFE) or hexafluoropropylene (HFP);
C₂-C₈hydrogenated fluoroolefins such as vinyl fluoride, 1,2-difluoroethylene and trifluoroethylene (TrFE), hexafluoroisobutene (HFIB),
perfluoroalkylethylenes of formula CH_{2═}CH—Rf₀, wherein Rf₀ is a C₁-C₆ perfluoroalkyl group;
chloro-and/or bromo-and/or iodo-C₂-C₆ fluoroolefins such as chlorofluoroethylene (CFE) or chlorotrifluoroethylene (CTFE);
perfluoroalkylvinylethers (PAVE) of formula CF₂═CF—O—Rf₁, wherein Rf₁ is a C₁-C₆ perfluorinated alkyl group e.g. CF₃, C₂F₅, C₃F₇;
partially fluorinated alkylvinylethers of formula CF₂═CF—O—Rf₂, wherein Rf₂ is a C₁-C₆ partially fluorinated alkyl group;
perfluoroalkoxyalkylvinylethers (PAAVEs) of formula CF₂═CF—O—X₀, wherein X₀ is a C₁-C₁₂ perfluorinated alkoxyalkyl group;
partially fluorinated alkoxyalkylvinylethers of formula CF₂═CF—O—X₁, wherein X₁ is a C₁-C₁₂ partially fluorinated alkoxyalkyl group;
partially fluorinated fluoroalkoxy alkyl vinyl ethers of formula CF₂═CF—O—X₂, wherein X₂ is a C₁-C₁₂ alkoxyalkyl group;
hydrofluoroalkylvinylethers complying with formula CH₂═CF—O—Y in which Y is a C₁-C₆ fluoro-or perfluoroalkyl, e.g. —CF₃, —C₂F₅, —C₃F₇;
fluorodioxoles, preferably perfluorodioxoles;
(per)fluoro-methoxy-vinylethers (MOVE, hereinafter) having formula:

CFZ═CZ—O—CF₂—O—Rf₃

wherein Rf₃ is selected among C₁-C₆ (per)fluoroalkyls, linear or branched; C₅-C₆ cyclic (per)fluoroalkyls; and C₂-C₆ (per)fluorooxyalkyls, linear or branched, comprising from 1 to 3 catenary oxygen atoms, and Z=F, H; preferably Z is F and Rf₃ is —CF₂CF₃ (MOVE1); —CF₂CF₂OCF₃ (MOVE2); or —CF₃ (MOVE3).

In some preferred embodiments, the fluorinated polymer (F) further comprises recurring units derived from at least one monomer selected from the group consisting of cis-1,2-difluoroethylene, trans-1,2-difluoroethylene, trifluoroethylene (TrFE), hexafluoropropylene (HFP), tetrafluoroethylene (TFE), chlorofluoroethylene (CFE), chlorotrifluoroethylene (CTFE) and perfluoroalkylvinylethers (PAVE) of formula CF₂═CF—O—Rf₁, wherein Rf₁ is a C₁-C₆ perfluorinated alkyl group.

The perfluoroalkylvinylether (PAVE) is preferably selected from the group consisting of perfluoromethylvinylether (PMVE) of formula CF₂═CF—O—CF₃, perfluoroethylvinylether (PEVE) of formula CF₂═CF—O—CF₂—CF₃ and perfluoropropylvinylether (PPVE) of formula CF₂═CF—O—CF₂—CF₂—CF₃. Also mixtures of different PAVEs can be used herein. In some embodiments, the fluorinated polymer (F) comprises, preferably consists essentially of, and more preferably consists of, recurring units derived from:
VDF and TFE;
VDF, TFE and CTFE;
VDF, TFE and PAVE;
VDF, TFE and HFP;
VDF, TFE, HFP and PAVE;
VDF and TrFE;
VDF, TrFE and CFE;
VDF, TrFE and CTFE;
VDF, TrFE and HFP;
VDF and CFE;
VDF and CTFE;
VDF and HFP;
VDF, HFP and PAVE; or
VDF, HFP and CTFE.

In some embodiments, the fluorinated polymer (F) comprises, preferably consists essentially of, and more preferably consists of (in mol %, with respect to the total moles of recurring units):
from 5% to 95% by mole of recurring units derived from vinylidene fluoride (VDF); and
from 5% to 95% by mole of recurring units derived from at least one additional fluorinated monomer.

In some other embodiments, the fluorinated polymer (F) comprises, preferably consists essentially of, and more preferably consists of:
from 15% to 35% by mole of recurring units derived from vinylidene fluoride (VDF); and
from 65% to 85% by mole of recurring units derived from at least one additional fluorinated monomer.

Still in some other embodiments, the fluorinated polymer (F) comprises, preferably consists essentially of, and more preferably consists of:
from 60% to 90% by mole of recurring units derived from vinylidene fluoride (VDF); and
from 10% to 40% by mole of recurring units derived from at least one additional fluorinated monomer.

In some embodiments, the fluorinated polymer (F) comprises, preferably consists essentially of, and more preferably consists of:
from 60% to 80% by moles of recurring units derived from vinylidene fluoride (VDF);
from 15% to 25% by moles of recurring units derived from hexafluoropropylene (HFP); and
from 5% to 15% by moles of recurring units derived from tetrafluoroethylene (TFE).

Good results were obtained with a fluorinated polymer (F) consisting of:
70% by moles of recurring units derived from vinylidene fluoride (VDF);
19% by moles of recurring units derived from hexafluoropropylene (HFP); and
11% by moles of recurring units derived from tetrafluoroethylene (TFE).

Optionally, fluorinated polymer (F) of the present invention also comprises recurring units derived from a bis-olefin [bis-olefin (OF)] having general formula:

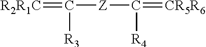

wherein R₁, R₂, R₃, R₄, R₅ and R₆, equal or different from each other, are H or C₁-C₅ alkyl; Z is a linear or branched C₁-C₁₈ hydrocarbon radical (including alkylene or cycloalkylene radical), optionally containing oxygen atoms, preferably at least partially fluorinated, or a (per)fluoropolyoxyalkylene radical, e.g. as described in EP 661304 A.

The bis-olefin (OF) is preferably selected from the group consisting of those complying with formulae (OF-1), (OF-2) and (OF-3):

### (OF-1)

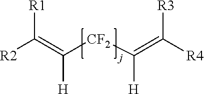

wherein j is an integer between 2 and 10, preferably between 4 and 8, and R₁, R₂, R₃, R₄, equal or different from each other, are H, F or C₁-5 alkyl or (per)fluoroalkyl group;

### (OF-2)

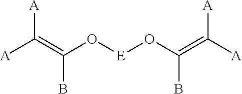

wherein each of A, equal or different from each other and at each occurrence, is independently selected from F, Cl, and H; each of B, equal or different from each other and at each occurrence, is independently selected from F, Cl, H and OR_{B}, wherein RB is a branched or straight chain alkyl radical which can be partially, substantially or completely fluorinated or chlorinated; E is a divalent group having 2 to 10 carbon atom, optionally fluorinated, which may be inserted with ether linkages; preferably E is a —(CF₂)ₘ- group, with m being an integer from 3 to 5; a preferred bis-olefin of (OF-2) type is F₂C═CF—O—(CF₂)₅—O—CF═CF₂.

### (OF-3)

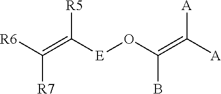

wherein E, A and B have the same meaning as above defined; R₅, R₆, R₇, equal or different from each other, are H, F or C₁-5 alkyl or (per)fluoroalkyl group.

Good results were obtained with bis-olefin of (OF-1) type of formula H₂C═CH—(CF₂)₆—CH═CH₂.

In some other embodiments, the fluorinated polymer (F) comprises, preferably consists essentially of, and more preferably consists of, the following monomers composition (in mol %, with respect to the total moles of recurring units):
(i) vinylidene fluoride (VDF) 35-85%, hexafluoropropene (HFP) 10-45%, tetrafluoroethylene (TFE) 0-30%, (per)fluoroalkylvinylethers (PAVE) 0-15%; bis-olefin (OF): 0-5%;
(ii) vinylidene fluoride (VDF) 50-80%, (per)fluoroalkylvinylethers (PAVE) 5 50%, tetrafluoroethylene (TFE) 0-20%, bis-olefin (OF): 0-5%;
(iii) vinylidene fluoride (VDF) 20-30%, C₂-C₈ non-fluorinated olefins (O1) 10 30%, hexafluoropropene (HFP) and/or (per)fluoroalkylvinylethers (PAVE) 18-27%, tetrafluoroethylene (TFE) 10-30%; bis-olefin (OF): 0-5%;
(iv) tetrafluoroethylene (TFE) 45-65%, C₂-C₈ non-fluorinated olefins (O1) 20 55%, vinylidene fluoride 5-30%; bis-olefin (OF): 0-5%;
(v) tetrafluoroethylene (TFE) 33-75%, (per)fluoroalkylvinylethers (PAVE) 15 45%, vinylidene fluoride (VDF) 5-30%, hexafluoropropene HFP 0-30%; bis-olefin (OF): 0-5%;
(vi) vinylidene fluoride (VDF) 35-85%, (per)fluoro-methoxy-vinylethers (MOVE) 5-40%, (per)fluoroalkylvinylethers (PAVE) 0-30%, tetrafluoroethylene (TFE) 0-40%, hexafluoropropene (HFP) 0-30%; bis-olefin (OF): 0-5%;

Optionally, the fluorinated polymer (F) of the present invention also comprises iodine and/or bromine cure sites.

These iodine and/or bromine cure sites might be comprised as pending groups bound to the backbone of the fluorinated polymer (F) chain or might be comprised as terminal groups of said polymer chain. According to a first embodiment, the iodine and/or bromine cure sites are comprised as pending groups bound to the backbone of the fluorinated polymer (F) chain; the fluorinated polymer (F) according to this embodiment typically comprises recurring units derived from brominated and/or iodinated cure-site comonomers selected from:
bromo and/or iodo alpha-olefins containing from 2 to 10 carbon atoms such as bromotrifluoroethylene or bromotetrafluorobutene described, for example, in U.S. Pat. No. 4,035,565 (DU PONT) 12 Jul. 1977 or other compounds bromo and/or iodo alpha-olefins disclosed in U.S. Pat. No. 4,694,045 (DU PONT) 15 Sep. 1987;
iodo and/or bromo fluoroalkyl vinyl ethers (as notably described in patents U.S. Pat. No. 454,662. U.S. Pat. No. 4,564,662 (MINNESOTA MINING) 14 Jan. 1986 and EP 199138 A (DAIKIN IND LTD) 29 Oct. 1986).

According to a second embodiment, the iodine and/or bromine cure sites (preferably iodine cure sites) are comprised as terminal groups of the fluorinated polymer (F) chain; the fluorinated polymer according to this embodiment is generally obtained by addition to the polymerization medium during fluorinated polymer (F) manufacture of at least one of:
iodinated and/or brominated chain-transfer agent(s); suitable chain-transfer agents are typically those of formula Rf₄(I)ₓ(Br)_{y}, in which Rf₄ is a (per)fluoroalkyl or a (per)fluorochloroalkyl containing from 1 to 8 carbon atoms, while x and y are integers between 0 and 2, with 1≤x+y≤2 (see, for example, patents U.S. Pat. No. 4,243,770 (DAIKIN IND LTD) 6 Jan. 1981 and U.S. Pat. No. 4,943,622 (NIPPON MEKTRON KK) 24 Jul. 1990); and
alkali metal or alkaline-earth metal iodides and/or bromides, such as described notably in patent U.S. Pat. No. 5,173,553 (AUSIMONT SRL) 22 Dec. 1992.

Advantageously, for ensuring acceptable reactivity it is generally understood that the content of iodine and/or bromine in the fluorinated polymer (F) should be of at least 0.05% wt. preferably of at least 0.06% weight, with respect to the total weight of fluorinated polymer (F).

On the other side, amounts of iodine and/or bromine not exceeding preferably 7% wt, more specifically not exceeding 5% wt, or even not exceeding 4% wt. with respect to the total weight of fluorinated polymer (F), are those generally selected for avoiding side reactions and/or detrimental effects on thermal stability.

Generally, the amount of iodine in the fluorinated polymer (F) ranges from 0.05% wt to 7% wt, preferably from 0.10% wt to 4.0% wt with respect to the total weight of fluorinated polymer (F).

In some preferred embodiments, iodinated chain-transfer agent are those of formula I —(CF₂)ₖ—I, in which k is an integer between 2 and 10.

Good results were obtained with I —(CF₂)₄-I as the iodinated chain-transfer agent. In some embodiments, the fluorinated polymer (F) of the present invention comprises recurring units derived from a bis-olefin [bis-olefin (OF)] as previously described and iodine atoms as end groups.

Good results were obtained using bis-olefin of (OF-1) type H₂C═CH—(CF₂)₆—CH═CH₂ and I—(CF₂)₄—I as the iodinated chain-transfer agent.

In some embodiments, the process comprising free radical polymerization in aqueous medium of at least one C₂-C₃ hydrofluoroolefin (HFO) in the presence of at least one surfactant (S) according to the invention is performed in the presence of at least one non-functional perfluoropolyether (PFPE).

Any non-functional perfluoropolyether composed of sequences of perfluorooxyalkylene units can be advantageously utilized. Generally suitable perfluoropolyethers have neutral end groups and an average molecular weight ranging from 300 to 3000. Suitable non-functional perfluoropolyethers are, for example, responding to the formulae:
i) R_{g}O(CF(CF₃)—CF₂O)_{q}(CFO(CF₃)); (CF₂O)ₛR_{g}′ with a random distribution of the perfluoro-oxyalkylene units; or
ii) R_{g}″O(CF₂CF₂O)_{q}(CFO(CF₃))ᵣ(CF₂O)ₛR_{g}′″ where R_{g} and R_{g}′, respectively R_{g}″ and R_{g}′, like or different from each other are —CF₃, —C₂F₅, —C₃F₇ and q, r, s, respectively q′, r′, s′, have such values as to meet the above said conditions regarding the average molecular weight.

Good results were obtained using Galden® DO2 available from Solvay of formula CF₃O(CF₂—CF(CF₃)O)ₒ(CF₂O)ₚCF₃ wherein o/p=20, having average molecular weight of 450.

In some embodiments, the process comprising free radical polymerization in aqueous medium of at least one C₂-C₃ hydrofluoroolefin (HFO) in the presence of at least one surfactant (S) according to the invention is performed in the presence of at least one nucleating agent. By nucleating agent is meant any agent suitable to promote latex particle formation and to allow for obtaining a fluorinated polymer having smaller primary particle size than that in the case of polymerization in the absence of said nucleating agent. Nucleating agents are well known by the person skilled in the art. Just for the sake of example nucleating agents include perfluoropolyether (PFPE) acid or salts thereof and nonionic surfactants such as nonionic hydrocarbon surfactants. Good results were obtained with hexafluoropropylene oxide oligomers bearing carboxylic acid group responding to formula C₃F₇O[CF(CF₃)CF₂O]ₜCF(CF₃)COOH wherein t is such that the average molecular weight Mw of said oligomers ranges from 1000 Da to 1500 Da, preferably from 1100 Da to 1400 Da, as nucleating agent. Depending on the chemical nature of nucleating agent, it is generally used in an amount equal or less than 1000 ppm; preferably equal or less than 500 ppm; more preferably equal or less than 100 ppm; sometimes equal or less that 10 ppm based on the aqueous medium. Good results were obtained with hexafluoropropylene oxide oligomers bearing carboxylic acid group in an amount equal or less than 100 ppm based on the aqueous medium.

Good results were obtained using Galden® D02 available from Solvay and hexafluoropropylene oxide oligomers bearing carboxylic acid group responding to formula C₃F₇O[CF(CF₃)CF₂O]ₜCF(CF₃)COOH, as previously defined, as nucleating agent.

The free radical polymerization in aqueous medium is typically carried out at a pressure comprised between 10 bar and 40 bar, preferably between 11 bar and 25 bar.

The polymerization temperature generally depends on, inter alia, the nature of the radical initiator used to initiate the free radical polymerization. The aqueous free radical polymerization is typically carried out at a temperature comprised between 50° C. and 135° C., preferably between 55° C. and 130° C. While the choice of the radical initiator is not particularly limited, it is understood that, being the reaction conducted in an aqueous medium, water-soluble radical initiators are preferred for initiating and/or accelerating the polymerization. Nevertheless also initiators which are non-soluble in water or which have a poor solubility, can still be used in the present invention. Both organic and inorganic radical initiators can be used in the process of the present invention. Suitable inorganic radical initiators include, but are not limited to, persulfates such as sodium, potassium and ammonium persulfates and hydrogen peroxide.

Also, organic radical initiators may be used and include, but are not limited to: acetylcyclohexanesulfonyl peroxide; diacetylperoxydicarbonate; dialkylperoxydicarbonates such as diethylperoxydicarbonate, dicyclohexylperoxydicarbonate, di-2-ethylhexylperoxydicarbonate; tert butylperoxyneodecanoate; 2,2′-azobis(4-methoxy-2,4-dimethylvaleronitrile; tert butylperpivalate; dioctanoylperoxide; dilauroyl-peroxide; 2,2′-azobis (2,4 dimethylvaleronitrile); tert-butylazo-2-cyanobutane; dibenzoylperoxide; tert-butyl-per-2ethylhexanoate; tert-butylpermaleate; 2,2′-azobis(isobutyronitrile); bis(tert-butylperoxy)cyclohexane; tert-butyl-peroxyisopropylcarbonate; tert-butylperacetate; 2,2′-bis(tert-butylperoxy)butane; dicumyl peroxide; di-tert-amyl peroxide; di-tert-butyl peroxide (DTBP); p-methane hydroperoxide; pinane hydroperoxide; cumene hydroperoxide; and tert-butyl hydroperoxide.

Other suitable radical initiators notably include halogenated free radical initiators such as chlorocarbon based and fluorocarbon based acyl peroxides such as trichloroacetyl peroxide, bis(perfluoro-2-propoxy propionyl) peroxide, [CF₃CF₂CF₂OCF(CF₃)COO]₂, perfluoropropionyl peroxides, (CF₃CF₂CF₂COO)₂, (CF₃CF₂COO)₂, {(CF₃CF₂CF₂)[CF(CF₃)CF₂O]ₘCF(CF₃) COO}₂ where m=0-8, [ClCF₂(CF₂)ₙCOO]₂, and [HCF₂(CF₂)ₙCOO]₂ where n=0-8; perfluoroalkyl azo compounds such as perfluoroazoisopropane. [(CF₃)₂CFN═]₂, R*N=NR*, where R* is a linear or branched perfluorocarbon group having 1-8 carbons; stable or hindered perfluoroalkane radicals such as hexafluoropropylene trimer radical. [(CF₃)₂CF]₂(CF₂CF₂)C^{·} radical and perfluoroalkanes.

Redox systems, comprising at least two components forming a redox couple, such as oxalate-permanganate, dimethylaniline-benzoyl peroxide, diethylaniline-benzoyl peroxide and diphenylamine-benzoyl peroxide may also be used as radical initiators in the present invention.

Among inorganic radical initiators particularly preferred are inorganic persulfates and in particular, potassium and/or ammonium persulfate. Good results were obtained with ammonium persulfate (APS).

Among organic radical initiators, peroxides having a self-accelerating decomposition temperature (SADT) higher than 50° C. are particularly preferred, such as for instance: di-tert-butyl peroxide (DTBP), diterbutylperoxyisopropylcarbonate, terbutyl(2-ethyl-hexyl)peroxycarbonate, terbutylperoxy-3,5,5-trimethylhexanoate.

One or more radical initiators as defined above may be added to the aqueous polymerization medium of the process of the invention in a total amount ranging advantageously from 0.001% to 20% by weight based on the weight of the aqueous polymerization medium.

Typically a small amount of initiator is introduced in the reactor at the beginning of the polymerization process, in order to get it started, and subsequently an additional amount of initiator is added continuously or stepwise to the reactor until the polymerization reaction is complete.

In some embodiments, the aqueous dispersion comprising particles of a fluorinated polymer (F) comprising recurring units derived from at least one C₂-C₃ hydrofluoroolefin (HFO), obtained by the process according to the invention is in the form of an aqueous latex therefore obtained by aqueous emulsion polymerization.

Thus, the invention also pertains to an aqueous latex obtainable by the process according to the invention as previously described.

It also pertains to an aqueous latex comprising at least one fluorinated polymer (F) and at least one partially fluorinated surfactant selected from the group consisting of compounds of formula (I), formula (II) and formula (III) as previously described.

Generally, the aqueous latex obtained by the process according to the invention comprises from 10% to 30% by weight of fluorinated polymer (F) as previously described with regard to the total weight of the aqueous latex.

Generally, the aqueous latex obtained by the process according to the invention comprises the fluorinated polymer (F) in the form of primary particles having an average primary particle size from 50 to 350 nm as measured according to ISO 22412 (2017).

By “average primary particle size” is meant the average size of primary particles of fluorinated polymer (F) obtainable by aqueous emulsion polymerization. For the purpose of the present invention, “primary particles” of fluorinated polymer (F) are to be intended distinguishable from agglomerates of primary particles. Aqueous latexes comprising primary particles of fluorinated polymer (F) are advantageously obtainable by the process according to the present invention comprising aqueous emulsion polymerization. Agglomerates of primary particles of fluorinated polymer (F) are typically obtainable by recovery and conditioning steps of fluorinated polymer (F) manufacture such as concentration and/or coagulation of aqueous fluorinated polymer (F) latexes and subsequent drying and homogenization thereby providing fluorinated polymer (F) powders.

As previously explained, fluorinated polymer (F) of the present invention comprises in some embodiments iodine and/or bromine cure sites, generally, in an amount ranging from 0.05% wt to 7% wt. preferably from 0.10% wt to 4.0% wt with respect to the total weight of fluorinated polymer (F). Such iodine containing fluorinated polymer (F) may be cured in the presence of at least one peroxide (P) which is able to generate radicals at relatively low temperature with suitable kinetics.

Therefore, another object of the invention is the use of the aqueous latex obtained by the process according to the invention in coating applications e.g. as dielectric coatings for capacitors or transistors.

Still another object of the invention is the use of the aqueous latex obtained by the process according to the invention in sealing or gasket applications e.g. for automotive.

Should the disclosure of any patents, patent applications, and publications which are incorporated herein by reference conflict with the description of the present application to the extent that it may render a term unclear, the present description shall take precedence.

### EXAMPLES

### Preparation of ICHFCOOEt (a)

Ethyl bromo fluoroacetate (0.24 mol, 1 eq) was added, in 1 h, to a stirred solution of anhydrous sodium iodide (0.29 mol 1.2eq) in dry acetone (240 cm3) at room temperature. When the addition was complete the reaction mixture was stirred at RT overnight. The suspension was diluted with diethyl ether (150 cm3) and filtered with a 0.45 μm PVDF membrane and the residual solid was re-washed with 2×25 cm³ of diethyl ether. The filtered solution was evaporated under vacuum and the residual red oil was dissolved in 150 cm3 of diethyl ether and washed with 150 cm³ of semi-saturated aq. Na₂S₂O₃. The organic phase was separated and washed again with demi-water, then it was separated and dried over Na₂SO₄.

The organic phase was distilled under reduced pressure to give 50 g of pure ethyl fluoroiodoacetate.

Ethyl fluoroiodoacetate (90%). Oil, 63-70° C. at 11/14 Torr.

### Preparation of Ethyl 2-Fluoro Decanoate (b)

A heterogeneous mixture of iron powder (0.06mol 0.3eq), 1-octene (0.78 mmol 4eq), ethyl fluoroiodoacetate (a) (45g 0.19mol 1 eq) and THF (490 cm³) was stirred at 70-80° C. (bath temp.) under nitrogen for 15 h, until complete conversion of fluoro iodo acetate. After cooling to RT, Zinc (0.29mol 1.5eq), ethanol (160 cm³) and acetic acid (69 cm³) were added under vigorous stirring and the reaction was left to reflux for an additional 2 h. The suspension was cooled, filtered on a Gauche D filter and the solid residue was washed with 2×30 cm³ of ethanol. The filtered solution was concentrated under vacuum obtaining a viscous pale yellow oil that was extracted with 300 cm³ of 10% NaHCO₃ and 300 cm³ of diethyl ether. The organic layer was separated while the aqueous phase was washed again with 300 cm³ of diethylether.

The combined organic layers were washed two times with 10% aq. NaHCO3 and water, and, then, dried over Na₂SO₄. The solvent was removed under vacuum and the desired product (b) was isolated as a pale yellow oil with 70% yield.

### Preparation of 2-Fluoro Decanoic Acid (c)

A 1M solution of ethyl 2-fluoro decanoate (b) (25g 0.12mol 1 eq) in methanol was added dropwise to a 150 cm³ 1M NaOH solution, cooled at 0° C. After the addition, the solution was stirred at RT for 2h. The methanol was removed under vacuum obtaining a dispersion of a white solid in water that was filtered on a 0.45 μm PVDF membrane. The collected white solid was washed with 2×100 cm³ fresh water and filtered again to give pure sodium 2-fluoro decanoate. The isolated white solid was treated with 1.2 eq of diluted HCl (11% in water) under stirring for 1h. Diethyl ether was added to the resulting mixture until complete dissolution of 2-fluoro decanoic acid. After the separation, the water phase was extracted with 2×70 cm³ of diethyl ether and the collected organic layers were dried over Na₂SO₄. The solvent was removed under vacuum to give a white crystal solid, overall yield 94%, which was confirmed to be the desired product (c) by ¹H and ¹⁹F NMR.

Preparation of 2-Fluoro Decanoic Ammonium Salt Water Solution (d) 2-fluoro decanoic acid (13g 0.068mol 1 eq) was charged into a flask with 24 g of water (35% wt water solution) at RT. The heterogeneous mixture was stirred vigorously. Ammonia solution (4.3 g, 0.075 mol 1.1 eq title 33%) was added dropwise till complete dissolution of the solid residue while monitoring temperature and pH (pH=7-8). The complete salification of the acid and the concentration of the final solution were determined by ¹H NMR (35% wt).

### Polymerization Materials

CH₃(CH₂)₇CHFCOO—NH₄ as surfactant was prepared as above described.
C6O4 is a commercial perfluorinated surfactant constituted by a mixture of diastereoisomers of ammonium 2,2-difluoro-2-{[2,2,4,5-tetrafluoro-5-(trifluoromethoxy)-1,3-dioxolan-4-yl]oxy}acetate used herein as a comparative surfactant.
nucleating agent was composed of oligomers of hexafluoropropylene oxide having carboxylic acid group responding to formula C₃F₇O[CF(CF₃)CF₂O]ₙCF(CF₃)COOH, having an average molecular weight Mw of 1300Da.
nucleating agent was introduced in the polymerization reactor simultaneously with the surfactant in the form of solutions in water respectively containing:
30 wt % of CH₃(CH₂)₇CHFCOO—NH₄, 5 wt % of nucleating agent and 65 wt % of water; or
30 wt % of the ammonium salt of perfluorinated C6O4 surfactant, 15 wt % of nucleating agent and 55 wt % of water.
1,4-diiodoperfluorobutane (C₄F₈I₂) as transfer agent was introduced in the polymerization reactor in the form of a 15wt % solution in Galden®D02.
bis-olefin of formula H₂C═CH—(CF₂)₆—CH═CH₂, was introduced in the polymerization reactor in the form of a 33wt % solution in Galden®D02.
ammonium persulfate (APS) as initiator was introduced in the polymerization reactor in the form of a 4wt % solution in demineralized water.

### Example 1

### Terpolymer VDF: 70% TFE: 11% HFP: 19% by Moles Nominal

In an AISI 316 steel vertical autoclave, equipped with baffles and stirrer working at 500 rpm, 3.3 1 of demineralized water were introduced. Then 6ml of an aqueous solution of surfactant CH₃(CH₂)₇CHFCOO—NH₄ at 35% wt/wt including 5% wt/wt of above described nucleating agent were introduced. Then 1.5 ml of a solution of Galden®D02 at 33% vol. of 1,4-diiodoperfluorobutane, 2 ml of Galden®D02 solution at 15% vol. of bis-olefin of formula H₂C═CH—(CF₂)₆—CH—CH₂, were introduced in the reactor. Then the temperature was raised up to the reaction temperature of 80° C. and when the later was reached, HFP (Hexafluoropropene) was introduced to generate a pressure variation of 12 abs bars. Next, a gas mixture of VDF: 70%, TFE: 11% and HFP: 19% by mole was added via a compressor, until reaching a pressure of 30 abs bars.

Then, 24 ml of a solution of 4wt. % of ammonium persulfate (APS) in demineralized water were fed. The polymerization pressure was maintained constant by feeding the above mentioned gas mixture.

When 140 g of gas mixture were reached, 2 ml of Galden®D02 solution at 15% vol. of bis-olefin, were introduced in the reactor and then every 120 grams of gas mixture up to 450 grams.

When 390 Grams of gas mixture were reached, 9 ml of a solution of Galden®D02 at 33% vol of 1,4-diiodoperfluorobutane and 8 ml of the solution of 4wt. % of ammonium persulfate (APS) in demineralized water were fed.

When 600g of the gas were fed the reactor was cooled at room temperature, the resulting latex was stripped in the autoclave and then was discharged, degassed and post treated by coagulation.

The recovered polymer was washed with demineralized water and dried at 90° C. for 16 hours.

### Comparative Example 2

### Terpolymer VDF: 70% TFE: 11% HPF: 19% by Moles Nominal

Same procedure as in the previous example 1 was followed, but introducing 6 ml of aqueous solution of ammonium salt of perfluorinated surfactant C6O4 at 45% wt/wt including 15wt. % of above described nucleating agent.

### Coagulation Procedure

250 ml of latex were poured using a dropping funnel in 3 liters of a of 2g/L water solution of Al₂(SO₄)₃ under stirring. The latex was poured within 10 minutes making the water slightly opaque. After few minutes nucleation occurred and bigger particle were generated. Water started becoming transparent and the particles size increased till the water turned to completely transparent. Then the water was removed by filtration and the resulting flaky polymer was washed by stirring it in another volume of water for 10 minutes. The polymer was filtered and washed 5 more times before being dried in an oven at 90° C. overnight.

TABLE 1
Polymer characterization

| | Surfactant | Particle | | | | |
|---|---|---|---|---|---|---|
| | (surfactant/ | average | | Tg*** | | Iodine |
| | nucleating agent/ | diameter* | Composition** | (° C.), | GPC**** | ***** |
| Ex. | H₂O) | (nm) | (NMR) | Cp | (Kda) | (wt %) |
| 1 | CH₃(CH₂)₇CHFCOO—NH₄ | 214 | VDF: 67.1 | −21 | Mw: | 0.18 |
| | (30/05/65) | | HFP: 21.9 | 0.232 | 184 | |
| | | | TFE: 11 | | Mn: 47 | |
| C. 2 | NH₄⁺ salt of C6O4 | 134 | VDF: 66.2 | −20.5 | Mw: | 0.31 |
| | (30/15/55) | | HFP: 22.2 | | 232 | |
| | | | TFE: 11.6 | 0.200 | Mn: 36 | |

*Particle average diameter was measured by Dynamic Light Scattering (DLS) specifically based on Photon Correlation Spectroscopy according to ISO 22412 (2017)
**Monomer composition was determined by ¹⁹F-NMR
***Glass transition temperature Tg was measured by differential scanning calorimetry (DSC)
****Average molecular weights Mn (number) and Mw (weight) were measured by gel permeation chromatography (GPC).
***** Iodine percentage was determined by X-ray fluorescence

It can be seen from the results compiled in Table 1 that partially fluorinated surfactant CH₃(CH₂)₇CHFCOO—NH₄ according to the invention is suitable to prepare an aqueous dispersion of particles of a fluorinated polymer, comprising recurring units derived from VDF such as VDF-HFP-TFE copolymers, having features such as composition, glass transition and molecular weights similar to those obtained for fluorinated polymers synthesized using perfluorinated C6O4 surfactant.

Moreover, partially fluorinated surfactant CH₃(CH₂)₇CHFCOO—NH₄ was evaluated according the carbon dioxide (CO₂) evolution test (OECD/TG 301 B). CH₃(CH₂)₇CHFCOO—NH₄ fulfilled the definition of ready biodegradable chemical as it reached 60% degradation fulfilling the 10-day window criteria. Moreover, it showed an average degradation of 71% at the end of the test i.e. 31 days (see table 2 below).

TABLE 2
Enhanced Ready Biodegradability Test (OECD/TG 301 B)

| | Degradation | Degradation |
|---|---|---|
| | average value at 17 | average value at |
| | days (end of the | 31 days (end of |
| Surfactant | 10-days window) (%) | the test) (%) |
| CH₃(CH₂)₇CHFCOO—NH₄ | 61% | 71%* |
| Conclusion | Readily Biodegradable | — |

*Individual result on 4 tests: A: 70%, B: 80%, C: 64%, D: 72%

Therefore, partially fluorinated surfactant CH₃(CH₂)₇CHFCOO—NH₄ is suitable to prepare fluorinated polymers through free radical polymerization in aqueous medium and to stabilize the dispersion of resulting fluorinated polymers, while being advantageously ready biodegradable chemical.

1. A process for manufacturing an aqueous dispersion comprising particles of a fluorinated polymer (F) comprising recurring units derived from a C₂-C₃ hydrofluoroolefin (HFO), said process comprising free radical polymerization in aqueous medium of at least one C₂-C₃ hydrofluoroolefin (HFO) in the presence of at least one partially fluorinated surfactant (S) selected from the group consisting of compounds of formula (I): R—CFX—P, formula (II): P—CFX—(CH₂)ₙ—CFX—P, and formula (III): R—CF(—P)₂ wherein
R is an optionally branched C₃-C₁₆ alkyl or alkenyl chain, optionally comprising one or more than one catenary heteroatoms selected from N, O and S, optionally comprising a carbonyl group, optionally comprising one or more than one halogen atoms selected from Cl, Br and I, and optionally comprising C₃-C₈ aliphatic cycles,
n is an integer from 2 to 16,
—P represents —COO—M, —SO₃—M or —PO₃—M, wherein M is H, or an alkali metal, or an ammonium group N(R′)₄, wherein R′, equal or different at each occurrence, is a hydrogen atom or a C₁-C₆ hydrocarbon group, and
X is H or F.

2. The process according to claim 1, wherein the C₂-C₃ hydrofluoroolefin (HFO) is selected from the group consisting of vinylidene fluoride (VDF), fluoroethylene, cis-1,2-difluoroethylene, trans-1,2-difluoroethylene, trifluoroethylene, 2,3,3,3-tetrafluoropropylene, cis-1,3,3,3-tetrafluoropropylene, trans-1,3,3,3-tetrafluoropropylene, cis-1,2,3,3-tetrafluoropropylene, trans-1,2,3,3-tetrafluoropropylene, 1,1,3,3-tetrafluoropropylene, 1,1,2,3-tetrafluoropropylene, cis-1,2,3,3,3-pentafluoropropylene, trans-1,2,3,3,3-pentafluoropropylene, 1,1,3,3,3-pentafluoropropylene, 1,1,2,3,3-pentafluoropropylene, 3,3,3-trifluoropropylene, 2,3,3-trifluoropropylene, cis-1,3,3-trifluoropropylene, trans-1,3,3-trifluoropropylene, cis-1,2,3-trifluoropropylene, trans-1,2,3-trifluoropropylene, 1,1,3-trifluoropropylene, 1,1,2-trifluoropropylene and mixtures thereof.

3. The process according to claim 1, wherein the C₂-C₃ hydrofluoroolefin (HFO) is vinylidene fluoride or 2,3,3,3-tetrafluoropropylene.

4. The process according to claim 1, wherein the partially fluorinated surfactant (S) is CH₃(CH₂)₇CHFCOO—NH₄ or CH₃—CO—(CH₂)₇CFHCOO—NH₄.

5. The process according to claim 1, wherein the fluorinated polymer (F) further comprises recurring units derived from at least one additional fluorinated monomer.

6. The process according to claim 5, wherein the at least one additional fluorinated monomer selected from the group consisting of cis-1,2-difluoroethylene, trans-1,2-difluoroethylene, trifluoroethylene (TrFE), hexafluoropropylene (HFP), tetrafluoroethylene (TFE), chlorofluoroethylene (CFE), chlorotrifluoroethylene (CTFE) and perfluoroalkylvinylethers (PAVE) of formula CF₂—CF—O—R_{f1}, wherein R_{f1} is a C₁-C₆ perfluorinated alkyl group.

7. The process according to claim 1, wherein the fluorinated polymer (F) essentially consists of recurring units derived from:
VDF and TFE;
VDF, TFE and CTFE;
VDF, TFE and PAVE;
VDF, TFE and HFP;
VDF, TFE, HFP and PAVE;
VDF and TrFE;
VDF, TrFE and CFE;
VDF, TrFE and CTFE;
VDF, TrFE and HFP;
VDF and CFE;
VDF and CTFE;
VDF and HFP;
VDF, HFP and PAVE; or
VDF, HFP and CTFE.

8. The process according to claim 1, wherein the fluorinated polymer (F) further comprises recurring units derived from at least one bis-olefin [bis-olefin (OF)] having general formula: 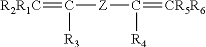
wherein R₁, R₂, R₃, R₄, R₅ and R₆, equal or different from each other, are H or C₁-C₅ alkyl; Z is a linear or branched C₁-C₁₈ hydrocarbon radical (including alkylene or cycloalkylene radical), optionally containing oxygen atoms, optionally at least partially fluorinated, or a (per)fluoropolyoxyalkylene radical.

9. The process according to claim 1, wherein the fluorinated polymer (F) contains iodine.

10. The process according to any one of the preceding claim 1, performed in the presence of at least one non-functional perfluoropolyether.

11. The process according to claim 1, performed in the presence of at least one nucleating agent.

12. The process according to any one of the preceding claim 1, wherein the aqueous dispersion comprising particles of a fluorinated polymer (F) is an aqueous latex.

13. An aqueous latex obtained by the process according to claim 1.

14. An aqueous latex comprising at least one fluorinated polymer (F) comprising recurring units derived from a C₂-C₃ hydrofluoroolefin (HFO) and at least one partially fluorinated surfactant (S) selected from the group consisting of compounds of formula (I) R—CFX—P (I), formula (II) P—CFX—(CH₂)ₙ—CFX—P (II), and formula (III) R—CF(—P)₂ wherein
R is an optionally branched C₃-C₁₆ alkyl or alkenyl chain, optionally comprising one or more than one catenary heteroatoms selected from N, O and S, optionally comprising a carbonyl group, optionally comprising one or more than one halogen atoms selected from Cl, Br and I, and optionally comprising C₃-C₈ aliphatic cycles,
n is an integer from 2 to 16,
—P represents —COO—M, —SO₃—M or —PO₃—M, wherein M is H, or an alkali metal, or an ammonium group N(R′)₄, wherein R′, equal or different at each occurrence, is a hydrogen atom or a C₁-C₆ hydrocarbon group preferably an alkyl group, and
X is H or F.

15. The aqueous latex according to claim 13 er 14-wherein the fluorinated polymer (F) is in the form of primary particles having an average primary particle size from 50 to 350 nm as measured according to ISO 22412.

16. (canceled)

17. The aqueous latex according to claim 14 wherein the fluorinated polymer (F) is in the form of primary particles having an average primary particle size from 50 to 350 nm as measured according to ISO 22412.
